(19) United States
(12) Patent Application Publication
(10) Pub. No.: US 2004/0243501 A1
(43) Pub. Date: Dec. 2, 2004

(54) System and method for automated data processing

(75) Inventor: William N. Duffey JR., Westwood, MA (US)

Correspondence Address: SYNNESTVEDT & LECHNER, LLP, 2600 ARAMARK TOWER, 1101 MARKET STREET, PHILADELPHIA, PA, 191072950

(73) Assignee: Regal Press, Inc., Norwood, MA

(21) Appl. No.: 10/447,850

(22) Filed: May 29, 2003

(51) Int. Cl. G06F 17/60

(52) U.S. Cl. 705/37

(57) ABSTRACT

A system and method for automated data processing whereby data is extracted from an e-mail message and passed to an external data processing system, e.g. for processing purchase orders. The purchaser can thereby communicate directly with a vendor's order processing system to initiate fulfillment of the purchase order without the need for human intervention. The method includes receiving an e-mail message having a body of text. Character strings of the body of text are compared to a database of valid key names to find a match. When a match is found, data associated with the character string in the body of text, as determined by convention, is stored in association with a respective key name. The data are purchaser-supplied values that are then transmitted to an external, e.g. order processing, system. A data processing system and a computer program product for extracting data from an e-mail message are also provided.

### FIELD OF THE INVENTION

The present invention relates generally to communication via a computer network, and more particularly to a system and method for automated processing of data submitted via an electronic mail message, e.g. to process a purchase order.

### DISCUSSION OF RELATED ART

According to conventional procurement procedures, an individual of an organization, institution, corporation, etc. often submits a formal purchase order to request that a vendor supply the individual, organization, institution, corporation, etc. (collectively, “purchaser”) with a certain product or service (collectively, “product”). Purchaser-approved purchase orders are often submitted to a vendor by mail, courier or facsimile transmission in handwritten or typed form, or by telephone in oral form. The purchase order typically identifies the purchaser and vendor, the desired product, shipping and billing addresses and any other information required to fulfil the purchase order by tendering the requested product.

For example, in the context of procurement of business cards or other customized printed documents, such other information typically includes information to be printed on the documents, (imprint information), such as first name, middle name, last name, corporate title, business name, business address, telephone number, facsimile number, e-mail address, etc. Similar information may be required for procurement of other printed documents, such as stationery, letterhead, envelopes, business forms, checks and security documents, pocket folders, specialty printing and merchandising collateral. Customized printed documents are then prepared to include such information, and those documents are shipped to the purchaser.

Traditionally, information from the purchase order is manually input by the vendor's employee into the vendor's system for processing the purchase order, e.g. to initiate fulfillment of the purchase order, attend to billing and/or payment matters, etc. Such order processing systems are well known in the art. Such systems may be computerized and may submit information to other external systems, e.g. to submit imprint information to automated printing equipment. The purchaser traditionally has not been able to communicate directly with the vendor's order processing system.

In recent years, computerized networks and electronic communications environments, such as the World Wide Web, have been used to conduct purchase and sale transactions, the field being generally referred to as “e-commerce.” Such Web-based e-commerce environments can allow a purchaser to communicate directly with a certain portion of the vendor's computer systems, e.g. to complete a purchase transaction. In the e-commerce context, vendors create and permit access to specially configured Web pages whereby a purchaser may use a Web browser and client computer to manually input (e.g. by typing) order information into established text-entry fields of a form displayed via the vendor's Web page. For example, such Web pages may collect information such as purchaser name, shipping address, credit card account number, etc. Such interactive forms for submitting information via the Web are typically implemented using a secure CGI interface, such as that presently available via URL http://www.commerce-cgi.com, and are well known in the art for exchange of information between parties.

Such interfaces are well suited for gathering a limited set of information, such as the purchaser name, shipping address, credit card account number, etc. that are required for virtually every purchase/sale transaction. However, not all employees have access to such Web-based interfaces, or wish to use them. Additionally, it is relatively complex, expensive and/or burdensome to provide a Web-based interface having such a broad range of fields that it will meet the requirements of various purchasers, each of which may have different requirements, or to provide customized Web-based interfaces for each such purchaser. For example, purchasers may have different requirements for the types of information to be included in customized printed documents for that purchaser.

According to prescribed work flow procedures of many purchasers, purchase orders/requests are routed through one or more authorized personnel before purchase order approval is obtained. Typically, communications concerning such approvals are performed by electronic mail (e-mail) messaging, which is well known in the art for intranet and Internet communications. The well known Web-based e-commerce interfaces are not compatible with prevalent e-mail based workflow procedures. Accordingly, an individual may receive instructions via e-mail to place an order with a vendor for a product, but that individual must manually take note of any order information from the e-mail message, access a vendor's Web-based interface, and manually input such information into that Web-based interface. Accordingly, there is no direct communication between the original e-mail sender and the vendor's order processing system; rather human intervention is required to bridge the gap between any e-mail communications and the vendor's order processing system.

### SUMMARY

Conceptually, the present invention provides a system and method for automated processing of data that bridges the gap between a sender's e-mail interface and a receiver's computerized system by automatedly extracting data from the sender's e-mail message and automatedly passing such data to the receiver's system. This is particularly useful in the context or processing purchase orders, such as purchase orders for customized printed materials. In this manner, the purchaser can communicate directly with the vendor's order processing system to initiate fulfillment of the purchase order without the need for human intervention. More particularly, purchaser-supplied data is identified, extracted and stored in a categorized manner using key name/value pairs by which data to be read (values) are associated with key names acting as markers/flags.

A computer-implemented method is provided for extracting data using a data processing system having a central processing unit (CPU) and a memory operatively connected to the CPU and being capable of communicating via a communications network. The method includes receiving, via the communications network, an e-mail message having a body of text. In accordance with the present invention, the body of text includes at least one key name, and a purchaser-supplied value for each key name. The method further includes storing each purchaser-supplied value in the memory in association with a respective key name. This may involve comparing a character string from the body of text to a stored database of valid key names to determine whether the character string includes one of the valid key names, and if so, reading data (i.e. the purchaser-supplied value) associated with the character string in the body of text. The determination of whether data is associated with the character string may be determined by reference to a predetermined convention specifying how to make this determination. The key name itself need not be stored, provided that the value (data) is stored in a manner that it is associated with the key name, so that it may be used for the purpose specified by the key name. The method also includes transmitting at least one purchaser-supplied value to another system for further processing of the data.

In a preferred embodiment, the e-mail message includes a vendor-supplied template including the key names, as well as purchaser-supplied values associated with the key names, the e-mail message sets forth a purchase order for a product, and the other system is an order processing system for fulfilling the purchase order.

A data processing system and a computer program product for extracting data from an e-mail message are also provided.

### BRIEF DESCRIPTION OF THE DRAWINGS

The present invention will now be described by way of example with reference to the following drawings in which:

FIG. 1 is a block diagram of an exemplary system and communications network environment in which the present invention may be employed;

FIG. 2 is a flow diagram illustrating an overview of an exemplary method for processing purchase orders in accordance with an exemplary embodiment of the present invention;

FIG. 3 shows an exemplary template for use in accordance with the present invention;

FIG. 4 shows the template of FIG. 3, shown partially completed to include purchaser-supplied information; and

FIG. 5 is a block diagram of the order processing system of FIG. 1.

### DETAILED DESCRIPTION

The present invention provides a system and method for automated processing of data that makes use of conventional electronic mail messaging infrastructure and techniques. The present invention is particularly well-suited to processing of data to facilitate a purchaser's submission of information required for processing a purchase order, and to provide a vendor with an automated means for extracting such information for use in processing the purchase order. In particular, information provided by the purchaser in textual form, either in an electronic mail message or in a document attached thereto and forwarded therewith (collectively, “e-mail message”). As well known in the art, e-mail messages are usually encoded in ASCII text and exchanged by telecommunication. Data is automatedly extracted from the e-mail message in accordance with the present invention, and passed to a conventional system, such as an order processing system that processes the purchase order in a straightforward, e.g. conventional, manner. For example, the order processing system may create a job ticket including pertinent data for use in manually fulfilling the purchase order, or may electronically forward pertinent and properly formatted data to a production queue of an automated computerized order fulfillment system, such as printing equipment for producing customized printed materials in the context of procurement of such documents.

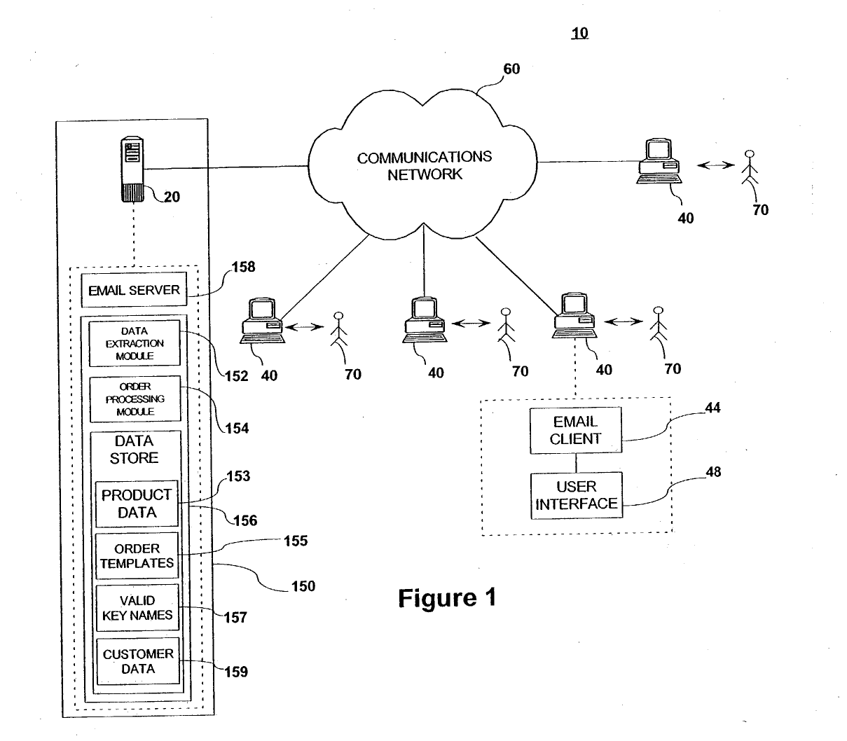

The present invention may be understood with reference to the exemplary, simplified network environment 10 of FIG. 1. As shown in FIG. 1, server hardware 20 of the inventive data processing system 150 can communicate with one or more client computers/devices 40 via a computer communications network 60. By way of example, the communications network 60 may include a local area network (LAN), wide area network (WAN), an intranet, the Internet, etc. Any network configuration allowing data to flow between points of access may be used. In this example, the communications network 60 is the Internet, and server 20 functions as an e-mail server, the data processing system 150, as well as an order processing system, although this functionality may be spread across multiple servers, as will be appreciated by those skilled in the art. Accordingly, the server 20 and client computers 40 can communicate with each other via a common protocol, such as Transport Control Protocol/Internet Protocol (TCP/IP), Simple Mail Transfer Protocol and/or POP3 protocol, as well known in the art. The server 20 is configured with conventional e-mail server software 158 for this purpose, such as Lotus Domino R5 software manufactured and/or distributed by International Business Machines Corporation of Armonk, N.Y., U.S.A. It will be understood by those skilled in the art that an actual network topology may include numerous clients and/or servers.

The client computer 40 interfaces with communications network 60 via e-mail client software 44 stored and/or running on the client computer 40 to allow a purchaser 70 to send and receive e-mail messages to and from server 20. Currently, various alternative e-mail client software applications, such as Microsoft® Outlook® software manufactured and/or distributed by Microsoft Corporation of Redmond, Wash., U.S.A., are commercially available for personal computers and other network-enabled devices, such as a mobile telephone, Internet appliance, personal digital assistant (PDA), etc. (collectively, “client computer”). The client computer 40 is configured to provide a graphical user interface 48 allowing the user to send and receive e-mail messages to and from the server 20, with or without file attachments, as generally known in the art for network communication in a network environment.

FIG. 1 further illustrates the data processing system 150, which includes a data extraction module 152, an order processing module 154, and a data store 156. The data store 156 and modules 152, 154 are shown logically in FIG. 1 for illustrative purposes, without regard to any particular embodiment in one or more instances of software or hardware. By way of example, the data store 156 may be a database implemented using a suitable commercially available database software program. Any suitable database architecture may be used, as will be appreciated by those skilled in the art. The data store 156 stores data including product data 153, order templates 155, valid key names 157 and customer data 159, as discussed further below. It should be noted that the order processing module 154 may be implemented using commercially available software such as Microsoft® Commerce Server 2000 software manufactured and/or distributed by Microsoft Corporation of Redmond, Wash., U.S.A., and that this module therefore represents a conventional order processing system, or a component thereof, such that once information is passed from the inventive data extraction module 152 to the order processing module 154, conventional type automated order processing may occur.

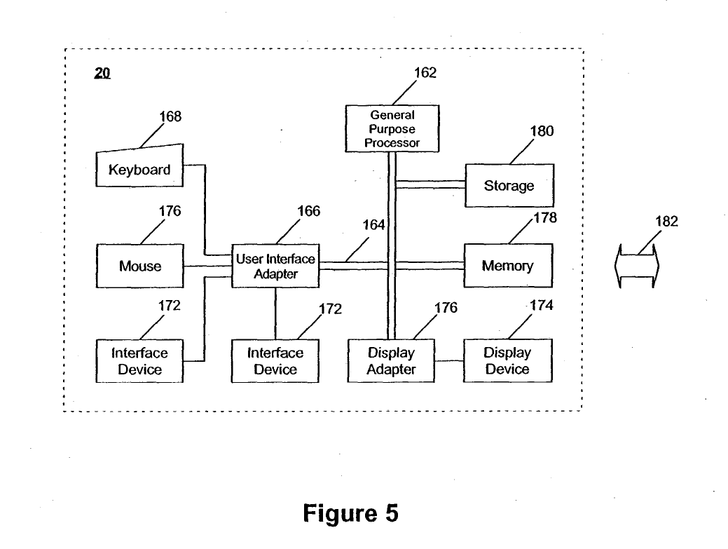

The server 20 of the data processing system 150 further includes various hardware, etc. of a type generally known in the art, as shown in FIG. 5 and discussed further below. As discussed further below, the modules 152, 154, data store 156 and e-mail server 158 are used in the course of receiving e-mail messages, extracting order data from such e-mail messages, and processing such data as desired, e.g. to fulfill purchase orders, as discussed further below.

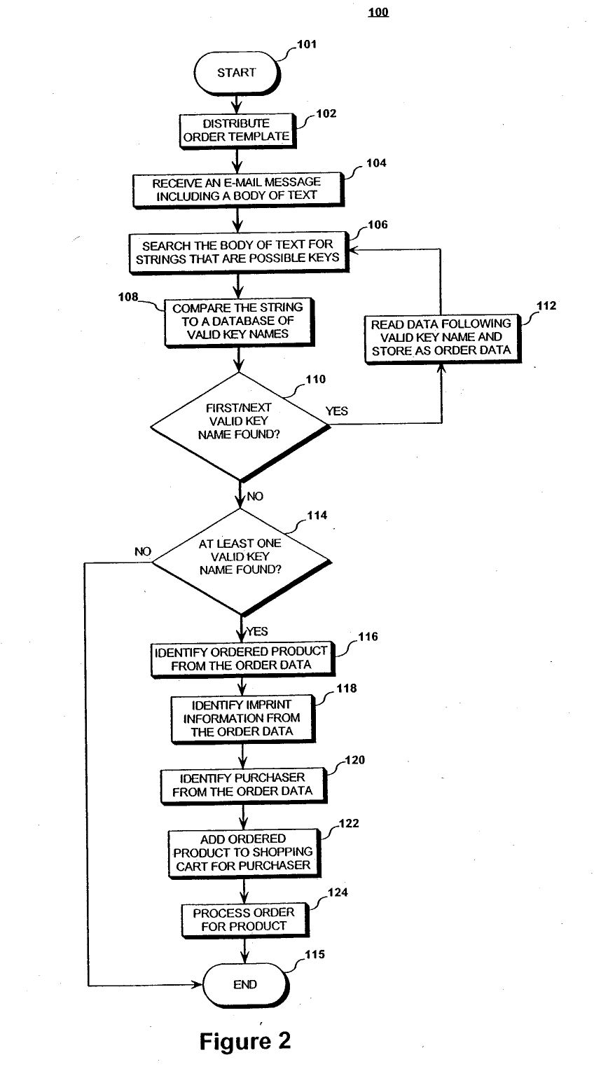

FIG. 2 shows a flow diagram 100 illustrating an exemplary method in accordance with the present invention. In the example of FIG. 2, the inventive method and system is discussed for illustrative purposes in the context of procurement of customized printed products. However, it will be appreciated that the invention is applicable to a broad range of products and services, and in fact is applicable to extraction of data from e-mail messages for purposes other than processing of purchase orders.

Referring now to FIG. 2, the exemplary method starts with distribution of a purchase order template, as shown at steps 101 and 102. This step is optional, as discussed further below. However, it is convenient for a purchaser in that it provides a template in the form of an editable electronic document (e.g. computer data file), such as an e-mail message or a word processor document attachable to an e-mail message. The template may be retrieved from order templates 155 stored in the data store 156 of the data processing system 150 (see FIG. 1). For example, the template may be transmitted to a purchaser/prospective purchaser via an e-mail message.

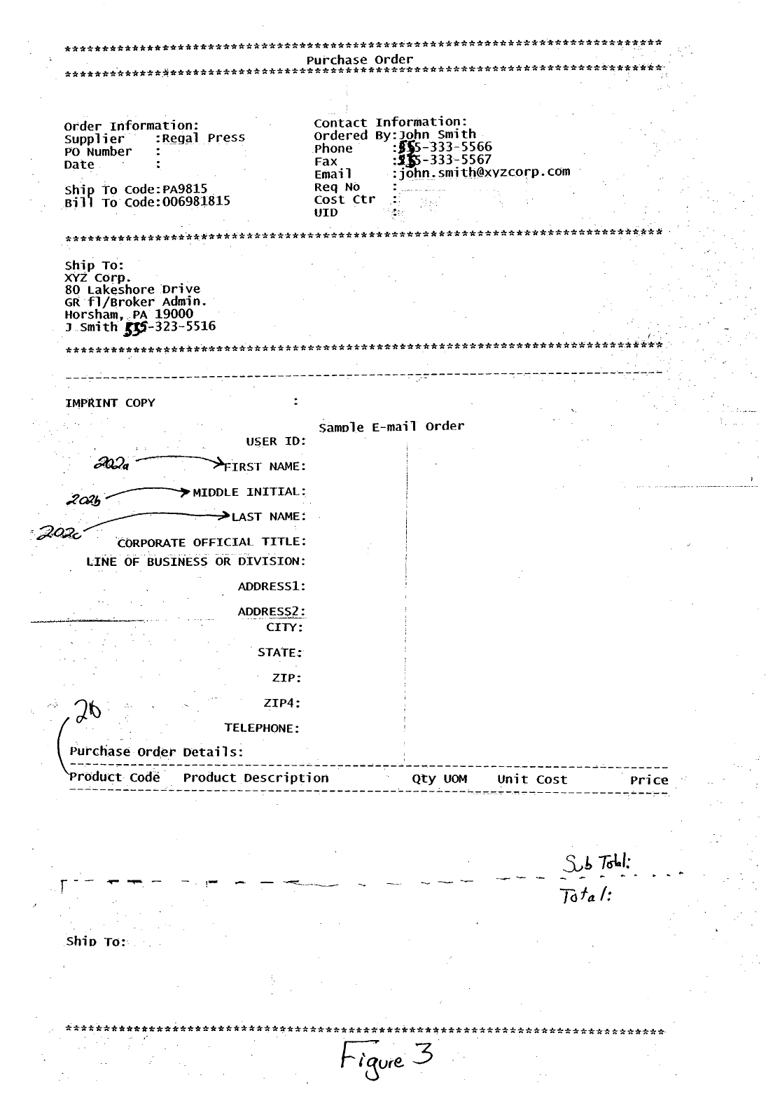

An exemplary template 200 is shown in FIG. 3. Referring now to FIG. 3, the template 200 is a textual document, e.g. an ASCII-encoded text file, and includes valid key names 202a, 202b, 202c, etc. and corresponding space 204a, 204b, 204c, etc. following the key names into which the purchaser may supply purchase-order specific information, e.g. by typing such information into the template using the purchaser's computer 40 and conventional word processor or e-mail composition software. For example, key name 202a is “FIRST NAME:”, which has a corresponding space 204a for receiving typed characters supplied by a purchaser to be taken as the corresponding key name value. The key name “FIRST NAME:” is valid in that it matches one of a plurality of key names stored as valid key names 157 in the system's data store 156 (FIG. 1).

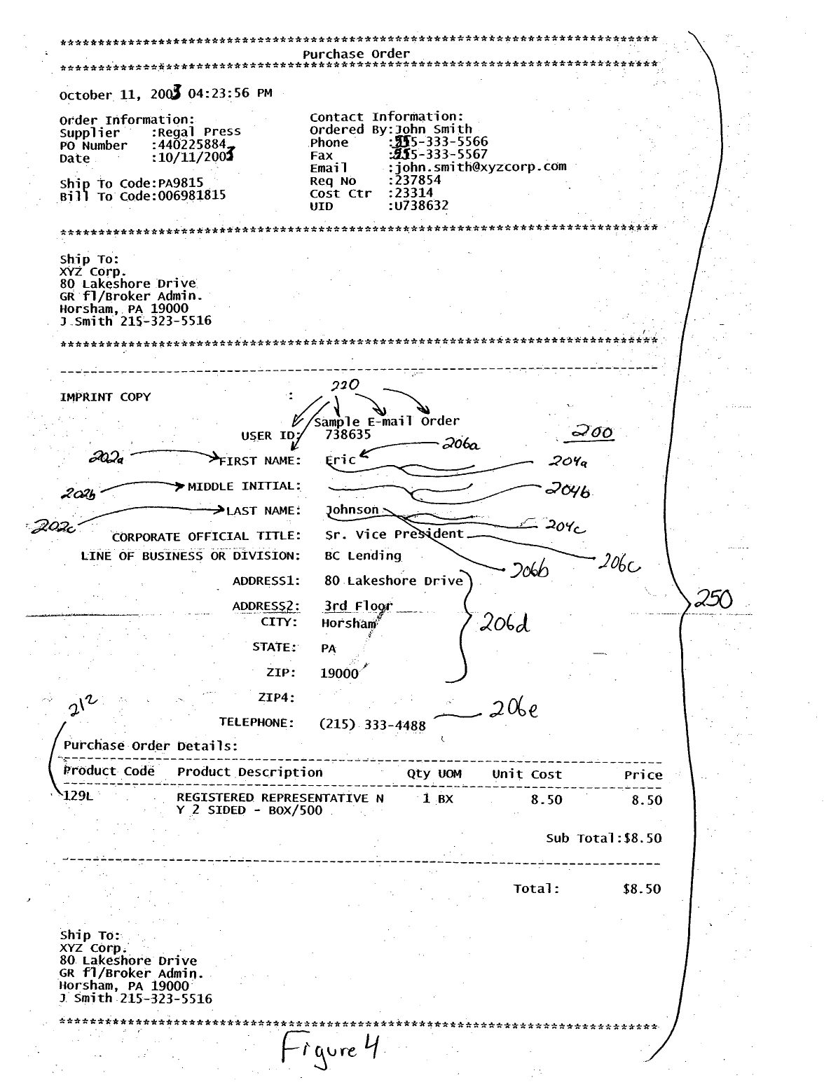

FIG. 4 shows the template 200 of FIG. 3, shown partially completed to include purchaser-supplied purchase-order specific information (values). As shown in FIG. 4, the value 206a is “Eric”, which corresponds to valid key name 202a “FIRST NAME:”. Accordingly, “Eric” will be printed as the first name when the order is processed, e.g. to create a document in which a first name is to be supplied, e.g. on a printed business card. It is noted that it is beyond the scope of the present invention as to how the value “Eric” will be used as the first name when the customized printed document is prepared. Conventional techniques, systems and software may be used for this purpose, such as Mpower Server 3.5 software manufactured and/or distributed by Pageflex, Inc. of Cambridge, Mass., U.S.A. Instead, the present invention is directed to receipt of data in an e-mail message, and extraction of data from that e-mail message, such that values are identified in association with valid key names, e.g. to recognize the user-supplied value “Eric” as information to be used as a first name.

It should be noted that after a set of valid key names are established, e.g. by convention, numerous different templates may be created that use various subsets of those key names, in various arrangements. Accordingly, customized templates may be created for each purchaser (e.g. corporation), if desired. In this manner, key names considered extraneous for a particular purchaser may be eliminated in a customized template for that purchaser. Additionally, for example, compliance with purchaser-specific procedures may be ensured, e.g. by including key names in the customized template that must be provided with corresponding data before the order will be processed, e.g. to include a purchaser-specified purchaser order number, name of an authorized procurement officer, etc. as the purchaser may require.

Advantageously, the purchaser may retain a copy of the template, and reuse the template as desired by supplying different information in the template as required, e.g. different names for different employees when ordering business cards for those employees. For example, the purchaser may retain the template as an e-mail message, or an attachment to an e-mail message, and may then complete and return the template to the vendor/data processing system via an e-mail message.

Referring again to FIG. 2, the vendor, or more specifically the vendor's data processing system 150, next receives an e-mail message, via the e-mail server 158, including a body of text 250 (FIG. 4), as shown at step 104. The body of text 250 includes the key names and purchaser-supplied information (values) corresponding to those key names. For example, the body of text may be the body portion of an e-mail message. Alternatively, the body of text may be the body of a document/file, such as a word processor document/file, attached to an e-mail message. The body of text, and any associated e-mail message, may be created and sent by the purchaser 70 using his client computer 40, and received by the e-mail server software 158 of the server 20/data processing system 150 via the communications network 60 (see FIG. 1). It should be noted that the e-mail message may be composed, sent, transmitted, and received as known in the art. The e-mail message may then be stored in memory of the server, etc.

Advantageously, the body of text may include the template, as discussed above. In this manner, the valid key names are already provided and the purchaser needs to provide only the purchaser-supplied information (values). However, in accordance with the present invention, the template need not be used, provided that key names and formatting following a prescribed convention are used, as discussed further below. In other words, valid key names and associated values may be submitted in an original document, or an original e-mail message, i.e. one not built from a template, provided that valid key names are used, and the values are arranged relative to the key names according to the established convention, as they would be in a template. The conventions are discussed further below.

When the e-mail message is initially received by the vendor, it may contain sufficient information for processing a purchase order, but it is not apparent to a vendor's conventional order processing system which information is pertinent, and how such information should be used. Traditionally, a human employee would read such information, manually/mentally identify its relevance, and manually input it into an order processing system, etc. The present invention allows this function to be performed in an automated fashion without the need for human intervention. Accordingly, the body of text 250 is next searched for character strings 220 (FIG. 4) that may be valid key names, as shown at step 106. This step is performed by the data extraction module 152 of system 150 (FIG. 1). More specifically, the server 20 is configured with microprocessor executable instructions for carrying out this function. For example, this step may be performed by software that reads/scans the body of text, line by line, for character strings 220 that match any one of the plurality of valid key names 157 stored in the data store 156 of the system 150. Each character string is compared to the valid key names 157 in the data store 156, as shown at step 108. For example, the valid key name “FIRST NAME:” may be stored in the valid key names 157 of the data store 156. When a match is found, the character string is detected as a valid key name, as shown at step 110. When a valid key name is found, e.g. “FIRST NAME:” as shown at 202a of FIG. 3, the data extraction module 152 reads the data associated with the valid key name and stores such data as order data to be used as information associated with the corresponding key name, as shown at step 112 of FIG. 2.

The data extraction module 152 determines which data is associated with a given key name by a predetermined convention. For example, the convention may be that any text on the same line of a document as a valid key name shall be read as data associated with that valid key name. By way of further example, the convention may be that any text following the valid key name and within a certain number of characters from the key name shall be read as data associated with that valid key name. By way of further example, the convention may be to use the number of characters following the valid key name as specified in the valid key names data store 157 or elsewhere. In this manner, each valid key name may accept a different number of characters as data in association with the valid key name. Alternatively, the convention may prescribe that all data between a first valid key name and a second valid key name shall be read as data associated with the first key name. Any suitable logic for determining which data is associated with a key name may be followed by the system 150 and/or designed into the data extraction module 152, as will be appreciated by those skilled in the art. Any order templates should be configured in accordance with the convention.

As shown in FIG. 4, “Eric” is the data associated with key name 202a, by an exemplary convention, and so would be stored as order data in step 112. It should be noted that the data is stored in association with the corresponding key name, such that there is a key name/value pair; in this example, “FIRST NAME:” is the key name and “Eric” is the corresponding value. “Eric” can subsequently be used as a first name in printed documents requiring a first name for the purpose of fulfilling the purchase order, printing a customized document, etc. In the preferred embodiment, the value is provided in the same line of text as the key name to facilitate detection and identify which value is associated with a key name.

The data extraction module 152 then continues searching the body of text 250 to find subsequent valid key names and corresponding values, as shown at steps 106-112. This manner of extraction of data from a document is sometimes referred to as “scraping” of data, although in typical “scraping,” all data is read and stored, and any undesirable/unnecessary information is discarded, filtered out, etc., as will be appreciated by those skilled in the art. In this manner, purchaser-supplied purchase order information/data in an e-mail message is extracted therefrom in an automated fashion, by the data extraction module 152. In addition, such extracted data is extracted and stored in a manner that the system associates the extracted data with corresponding key names to identify what the extracted data represents so the extracted data can be used in an appropriate manner by the order processing or other external system, e.g. to use shipping address data as a shipping address, the first and last name imprint data as a first and last name when printing customized documents, etc. The extracted data may thus be provided to an external (logically, but not necessarily physically, separate) computerized system as input for use as information corresponding to the key name, e.g. as input data provided in proper input fields of the external system. In this manner, the extracted data is not only obtained, but also is identified as to the purpose for which the data should be used. Accordingly, the extracted data may be arranged, formatted, etc. as appropriate so the data may be transmitted to an order processing system in a manner ensuring proper interpretation by the order processing system. By way of example, suitable software for automatedly extracting data in this manner may be developed using Microsoft Corporation's ASP 3.0 technology including VBScript scripting language, FileSystem objects for accessing the purchase order text file, and ActiveX Data Objects (ADO) technology for accessing the databases. This extraction of data continues until no more valid key names are found, as shown at step 110.

If no valid key names are found, the method ends, as shown at steps 114 and 115. However, if at least one valid key name is found, the extracted order data is used to process the order, as shown at step 114. In particular, the data extraction module 152 of the system 150 next identifies an ordered product from the order data extracted and stored in step 112, as shown at step 116. For example, this step may involve extracting purchaser-supplied data 212 (FIG. 4) following a Product Code key name 210 (FIG. 3), or using the product catalog in the vendor's order processing system (e.g. via MS Commerce Server 2000 software), e.g. to insert into the purchase order product description data retrieved from the product catalog using a Product Code or other data extracted from the purchaser-supplied data 212. The Product Code value 212 provided by the purchaser following the Product Code key name 210 may optionally be compared against a database 153 (FIG. 1) of available products/products codes, a catalog, etc. to find a match. For example a Product Code value of 129L (see FIG. 4) may indicate a product that is a set of 500 customized business cards printed on premium paper, etc., as can be determined by reference to the product database 153. By way of example, this may be performed in an automated fashion by suitable software, such as Microsoft's Commerce Server 2000 software, as well known in the art.

In this example, which is in the context of procurement of customized printed documents, imprint information is next identified from the order data extracted and stored in step 112, as shown at step 118. For example, such imprint information may include a first name 206a, last name 206b, title 206c, address information 206d, telephone number 206e, etc. for an employee for whom business cards are being ordered. Such imprint information will be incorporated into the customized printed products that are being ordered. It will be appreciated that in other, non-printing based applications, there may be no such imprint information.

A purchaser is then identified from the order data extracted and stored in step 112, as shown at step 120. The purchaser may be spelled out, identified by a customer number, etc. By way of example, a purchaser may be identified by comparing purchaser order data to a customer data database 159 stored in the data store 155 of the system 150 (FIG. 1) after extracting such purchase order data from the e-mail message, or the system can be configured so that a new purchaser profile is always created in the database using the extracted order data. This may be performed by the data extraction module 152. Accordingly, for example, a purchaser may provide only an identification number in an e-mail message, and corresponding shipping information, billing information, etc. may be retrieved from the customer data database 159 and be used to process the purchase order. If no match is found in the customer data database 159, then a new customer record may be created using the data extracted from the e-mail message, and such information may then be stored in the customer data database 159 for future reference. It should be noted that a user profile (e.g. a business card recipient) may be created and stored in the customer data database 159, similarly to such customer/purchaser profiles.

The data extraction module 152 then adds the ordered product to a “shopping cart” or “shopping basket” for the purchaser and the order for the product is processed, as shown at steps 122 and 124, and the method ends, as shown at step 115. It is intended that this step be read broadly to encompass any technique for marking a product as a product that is to be purchased, such that conventional order processing software and techniques, such as conventional Web-based e-commerce software and techniques, may be used. The general concept of marking a product for purchase by adding it to a conceptual “shopping cart” or “shopping basket” is well known in the art in Web-based e-commerce applications. For example, it is known in the art to maintain a Web-page having an interactive (CGI) form for receiving data from a purchaser, and to have e-commerce order processing software for receiving payment, obtaining credit card approvals, tracking inventory, generating receipts, etc. after a user has added a product to his conceptual shopping cart and initiates a checkout/purchase procedure. Specifically, these steps involve transmitting information to a conventional order processing system such that the order may be processed in a conventional manner. It is intended that such conventional order processing is performed by the order processing module 154 after the data extraction module 152 has extracted data from an e-mail message and added a corresponding product to the conceptual shopping cart/basket of the purchaser. Accordingly, a conventional order processing system may be employed, such as a server configured with Microsoft Corporation's Commerce Server 2000 software, which interacts with the order processing module 154 and data extraction module 152 to carry out the present invention using conventional programming technologies, such as Microsoft's ASP 3.0.

By way of example, processing the order for the product may involve attending to purchase, payment, and/or billing issues, gathering shipping information, gathering instructions for fulfilling the order, etc. as known in the art. Post-manufacture, e.g. shipping, steps may involve human interaction to package boxes, load them on trucks, etc., as known in the art. Such processing may further include automated sending of confirmation e-mail messages to the purchaser to confirm that the order has been placed and is being processed, that the product has been shipped, etc., automated generation of proofs for printed materials in the form of *.pdf of other formats (e.g. for viewing on-line in an e-mail message or Web environment), automated queuing of required data to a production queue for a system for producing printed documents, automated generating of job tickets for manual use and/or entry in a production line, automated generating of a packing list, etc. It will be appreciated that any suitable steps may be followed in processing the order in step 124, as will be appreciated by those skilled in the art.

In this manner, information required to process a purchase order is submitted by a purchaser to a vendor in an e-mail message format, and is extracted by the vendor's system in a novel, automated fashion. Accordingly, information for fulfilling a purchase order for customized printed documents is gathered in a novel manner, and submitted to a conventional order processing system in a novel manner. Advantageously, the automated data processing system effectively allows a purchaser direct access to printed materials by causing his e-mail purchase order to directly communicate with a vendor's conventional order processing system to trigger manufacture of corresponding documents, without the need for human intervention (e.g. vendor personnel), and in fact automate the entire sourcing, tracking, manufacturing, billing, and order fulfillment processes. Because of the arrangement, recognition and reading of data in key name/value pairs, any e-mail message/document format/layout may be used, provided that valid key names and data formatting conventions are followed. Additionally, the inventive system and method is compatible with e-mail based workflow processes of purchasers, permitting e-mail based approval and placement of purchase orders. For example, an authorized purchaser may transmit a single e-mail message that sends a copy to the vendor/vendor's data processing system 150, accounts payable personnel, a business card recipient, etc., thereby notifying relevant personnel of placement of a purchaser order while simultaneously preparing and submitting the purchase order to the vendor.

FIG. 5 is a block diagram of a server 20 of the data processing system 150 (see FIG. 1) in accordance with the present invention. As is well known in the art, the server 20 of FIG. 5 includes a general purpose microprocessor (CPU) 162 and a bus 164 employed to connect and enable communication between the microprocessor 162 and the components of the server 20 in accordance with known techniques. The server 20 typically includes a user interface adapter 166, which connects the microprocessor 162 via the bus 164 to one or more interface devices, such as a keyboard 168, mouse 170, and/or other interface devices 172, which can be any user interface device, such as a touch sensitive screen, digitized entry pad, etc. The bus 164 also connects a display device 174, such as an LCD screen or monitor, to the microprocessor 162 via a display adapter 176. The bus 164 also connects the microprocessor 162 to memory 178 and long-term storage 180 (collectively, “memory”) which can include a hard drive, diskette drive, tape drive, etc. It should be appreciated that the data stored in the data store 156 of FIG. 1 may be stored in one or more of the memory 178 and long-term storage 180.

The server 20 may communicate with other computers or networks of computers, for example via a communications channel, network card or modem 182. The server 20 may be associated with such other computers in a local area network (LAN), a wide area network (WAN), intranet, Internet, etc. All of these configurations, as well as the appropriate communications hardware and software, are known in the art.

Software programming code for carrying out the inventive method is typically stored in the memory of the server 20. Accordingly, the server 20 stores in its memory microprocessor executable instructions for: receiving, via the communications network, an e-mail message having a body of text, the body of text including a key name, and a purchaser-supplied value for the key name; storing the purchaser-supplied value in the memory in association with the key name; and/or transmitting the purchaser-supplied value to a separate system, such as an order processing system for fulfilling the purchase order.

Optionally the server may store in its memory additional instructions for: searching the body of text to identify a character string; comparing the character string to a plurality of valid key names stored in the memory to determine whether the character string includes one of the plurality of valid key names; and reading data associated with the character string in the body of text if the character string includes one of the plurality of valid key names.

Additionally, computer readable media storing computer readable code for implementing the method steps is provided (see discussion of method steps above). Any suitable form of computer readable media may be used.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A computer-implemented method for processing data using a data processing system having a central processing unit (CPU) and a memory operatively connected to the CPU and being capable of communicating via a communications network, the method comprising:
receiving, via the communications network, an e-mail message having a body of text, the body of text including a key name, and a respective purchaser-supplied value associated with the key name; and
storing the purchaser-supplied value in the memory in association with the key name.

2. The method of claim 1, further comprising:
transmitting the purchaser-supplied value as input to a separate system for use as information corresponding to the key name.

3. The method of claim 1, wherein the storing comprises:
searching the body of text to identify a character string;
comparing the character string to a plurality of valid key names stored in the memory to determine whether the character string includes one of the plurality of valid key names; and
if the character string includes one of the plurality of valid key names, reading the purchaser-supplied value associated with the character string in the body of text.

4. The method of claim 3, wherein whether the purchaser-supplied value is associated with character string is established by a predetermined convention.

5. The method of claim 4, wherein the predetermined convention provides that all data between a first valid key name and a second valid key name shall be read as data associated with the first valid key name, and wherein searching the body of text comprises identifying first and second character strings that are first and second valid key names of the plurality of valid key names.

6. The method of claim 2, wherein the separate system comprises an order processing system for fulfilling purchase orders, and the e-mail message comprises a purchase order.

7. The method of claim 6, further comprising using the purchaser-supplied value in fulfilling the purchase order, the purchaser-supplied value being used by the order processing system as information as information corresponding to the key name.

8. The method of claim 7, further comprising:
printing a document, the document including printed text displaying the purchaser-supplied value.

9. The method of claim 7, further comprising:
identifying a product, the product being identified by the purchaser-supplied value.

10. The method of claim 9, wherein the identifying comprises referencing a database of product data to identify a product corresponding to the purchaser-supplied value.

11. The method of claim 7, further comprising:
distributing an order template to a purchaser, the order template comprising the key name.

12. The method of claim 11, wherein the distributing comprises transmitting the order template to the purchaser via e-mail transmission.

13. The method of claim 1, further comprising:
printing a document, the document including printed text displaying the purchaser-supplied value.

14. The method of claim 3, further comprising:
printing a document, the document including printed text displaying the purchaser-supplied value.

15. A computer-implemented method for processing a purchase order using a data processing system having a central processing unit (CPU) and a memory operatively connected to the CPU and being capable of communication via a communications network, the method comprising:
receiving, via the communications network, an e-mail message having a body of text;
searching the body of text to identify a character string;
comparing the character string to a plurality of valid key names stored in the memory to determine whether the character string includes one of the plurality of valid key names;
if the character string includes one of the plurality of valid key names:
reading data associated with the character string in the body of text, the data associated with the character string being established by a predetermined convention;
storing the data in association with the one of the plurality of valid key names;
communicating the at least one purchaser-supplied value to an order processing system; and
the order processing system processing the order to automatedly print a document including printed text displaying the at least one purchaser-supplied value as information for the respective one of the plurality of key names.

16. The method of claim 15, wherein the predetermined convention provides that all data between a first valid key name and a second valid key name shall be read as data associated with the first valid key name, and wherein searching the body of text further comprises identifying a second character string and comparing the second character string to the plurality of valid key names stored in the memory to determine whether the second character string includes one of the plurality of valid key names.

17. The method of claim 15, further comprising:
identifying a product, the product being identified by the at least one purchaser-supplied value.

18. The method of claim 17, wherein the identifying comprises referencing a database of product data to identify a product corresponding to the at least one purchaser-supplied value.

19. A data processing system for extracting data from an e-mail message, said data processing system comprising:
a microprocessor;
a memory operatively connected to said microprocessor;
a telecommunications device operatively connected to said microprocessor and capable of communicating via a communications network;
first instructions stored in said memory and executable by said microprocessor for receiving, via the communications network, an e-mail message having a body of text, the body of text including a plurality of key names, and a purchaser-supplied value for each of said plurality of key names;
second instructions stored in said memory and executable by said microprocessor for storing each purchaser-supplied value in the memory in association with a respective one of the plurality of key names; and
third instructions stored in said memory and executable by said microprocessor for transmitting at least one purchaser-supplied value to an order processing system for fulfilling the purchase order.

20. The data processing system of claim 19, further comprising:
fourth instructions stored in said memory and executable by said microprocessor for searching the body of text to identify a character string;
fifth instructions stored in said memory and executable by said microprocessor for comparing the character string to a plurality of valid key names stored in the memory to determine whether the character string includes one of the plurality of valid key names; and
sixth instructions stored in said memory and executable by said microprocessor for reading data associated with the character string in the body of text if the character string includes one of the plurality of valid key names.

21. A computer program product embodied in one or more computer-readable media, the computer program product adapted for extracting data from an e-mail message and comprising:
computer-readable program code for receiving, via the communications network, an e-mail message having a body of text, the body of text including a plurality of key names, and a purchaser-supplied value for each of said plurality of key names;
computer-readable program code for storing each purchaser-supplied value in the memory in association with a respective one of the plurality of key names; and
computer-readable program code for transmitting at least one purchaser-supplied value to an order processing system for fulfilling the purchase order.

22. The computer program product of claim 21, further comprising:
computer-readable program code for searching the body of text to identify a character string;
computer-readable program code for comparing the character string to a plurality of valid key names stored in the memory to determine whether the character string includes one of the plurality of valid key names; and
computer-readable program code for reading data associated with the character string in the body of text if the character string includes one of the plurality of valid key names.
